(19) United States
(12) Patent Application Publication
(10) Pub. No.: US 2015/0323170 A1
(43) Pub. Date: Nov. 12, 2015

(54) WATERPROOF STRUCTURE OF HANDHELD LAMP

(71) Applicant: SHIN CHIN INDUSTRIAL CO., LTD., TAINAN CITY (TW)

(72) Inventor: CHENG MING SU, TAINAN CITY (TW)

(73) Assignee: SHIN CHIN INDUSTRIAL CO., LTD., TAINAN CITY (TW)

(21) Appl. No.: 14/273,844

(22) Filed: May 9, 2014

(51) Int. Cl. F21V 31/04

(52) U.S. Cl. CPC F21V 31/04; F21W 2131/30

(57) ABSTRACT

A waterproof structure of a handheld lamp installed at a power socket includes a base having an accommodating space, a circuit board installed in the accommodating space, a port soldered to the circuit board and corresponsive to a slot of the base, and a thermosetting gel covered onto the port and the soldered portion of the circuit board and the port. The base has a corresponding cover made of a thermosetting gel by injection, so that the cover is packaged into the base, and the circuit board and the port are packaged in the base and the cover, and an interface of the port will not produce any gap. Therefore, moisture or dust will not enter from the interface to achieve the waterproof and dustproof effects.

### FIELD OF THE INVENTION

The present invention relates to a waterproof structure of a handheld lamp, and more particularly to the waterproof structure that provides a waterproof function of the handheld lamp by covering a thermosetting gel onto the handheld lamp through an injection method.

### BACKGROUND OF THE INVENTION

Various different types of flashlights used in our daily life or work or handheld lamps used for maintenance and repair are developed to meet the requirement of our daily use Conventional light bulbs not just have the disadvantages of large volume, high power consumption, short life, but also requires a troublesome and time-consuming recycle process. As science and technology advance, conventional light bulbs are gradually replaced by LED lamps to achieve a better environmental protection effect.

Since LED lamps have the features of low heat generation, high power-saving effect and long service life, therefore different ways of supplying power to the lamp are developed. To improve the convenience of use, the LED lamp is designed with a USB port, so that the lamp can be connected to a computer device through a transmission line or connected to a general socket for charging the lamp through an adapter. However, connectors of the electronic products usually do not come with the waterproof function, so that moisture in the air may enter into the connectors and causes a short circuit, particularly in a humid or wet environment. As a result, the transmission is affected, or even worse the components inside the lamp are damaged.

To overcome problem of the poor waterproof effect of the USB port of the LED lamp, R.O.C. Pat. No. M454512 has disclosed a “waterproof USB lamp” comprising a tube, a first through hole and a second through hole formed on the tube, a circuit module installed in the tube and having a switch portion and a USB interface aligned corresponsive to the first through hole and the second through hole respectively, a first waterproof plug plugged into the first through hole and having a latch groove formed on a side of the first waterproof plug and corresponsive to the switch portion for latching into the first through hole, a slot formed at the first waterproof plug, such that the switch portion tightly attaches the first waterproof plug through the slot, and a second waterproof plug plugged into the second through hole to prevent liquid from entering. However, the second through hole with the embedded USB interface are plugged by a movable second waterproof plug only, so that when the USB interface is used, it is necessary to remove the second waterproof plug in order to connect a USB connector for charging. After removing and plugging the second waterproof plug for several times, the second waterproof plug may not be able to maintain the waterproof effect due to elastic fatigue.

### SUMMARY OF THE INVENTION

In view of the aforementioned drawback of the USB port of the conventional lamp that is plugged by a movable waterproof plug only and moisture may enter from the gap after the movable waterproof plug has been used for a while and become elastic fatigue or damaged, and still have poor waterproof effect, it is a primary objective of the present invention to coat a thermosetting gel onto the port soldered onto a circuit board to prevent moisture or dust from entering through the port.

Another objective of the present invention is to form a cover by injecting a thermosetting gel, so that the cover is integrally formed and packaged onto the base to skip the assembling of the cover and the base and lower the manufacturing cost.

To achieve the aforementioned objectives, the present invention provides a waterproof structure of a handheld lamp, and the waterproof structure is installed in a power socket, and the power socket comprises:

a base, having an accommodating space, two penetrating holes and a slot; a circuit board, installed in the accommodating space of the base; a port, soldered to the circuit board, and disposed at a position corresponding to the slot of the base; a thermosetting gel, coated onto the port; two first electronic wires, each having an end soldered to the circuit board, and the other end soldered to an electrical storage device; two contact points, disposed at positions corresponding to the penetrating holes of the base respectively; two second electronic wires, each having an end soldered to the circuit board, and the other end soldered to the contact point; and a cover, formed by injecting the thermosetting gel, and packaged onto the base. Therefore, the circuit board and the port are packaged into the base and the cover, so that the interface of the port will not produce any gap, and moisture or dust will not enter from the interface to achieve the waterproof and dustproof effects.

The waterproof structure of a handheld lamp in accordance with the present invention is manufactured by the following method comprising the steps of: soldering a port to a circuit board, coating a thermosetting gel onto the port and the circuit board and the soldered portion of the port by injection after the soldering takes place and just keeping the interface of the port, soldering an end of the first electronic wire to the circuit board, and soldering an end of the second electronic wire to the contact point, putting the soldered contact point and second electronic wire into a base, soldering the other end of the second electronic wire to the circuit board, putting the soldered circuit board into the base, and finally integrally forming a cover by a thermosetting gel through an injection method, so that the cover is packaged onto the base, and the other end of the first electronic wire is passed through the base to facilitate soldering with the electrical storage device.

The specific structure and practical functions of the present invention will be apparent with the description of the following preferred embodiment accompanied with the illustration of related drawings as follow.

### BRIEF DESCRIPTION OF THE DRAWINGS

FIG. 1 is an exploded view of a power socket of the present invention;

FIG. 2 is a flow chart of manufacturing a waterproof structure of the present invention;

FIG. 3-A is a schematic view of a first manufacturing process of a waterproof structure of the present invention;

FIG. 3-B is a schematic view of a second manufacturing process of a waterproof structure of the present invention;

FIG. 3-C is a schematic view of a third manufacturing process of a waterproof structure of the present invention;

FIG. 4 is a cross-sectional view of a power socket of the present invention;

FIG. 5 is another cross-sectional view of a power socket of the present invention viewing from another angle;

FIG. 6 is an exploded view of a handheld lamp of the present invention;

FIG. 7 is a cross-sectional view of a handheld lamp of the present invention;

FIG. 8 is a perspective view of a handheld lamp of the present invention; and

FIG. 9 is a perspective view of a handheld lamp of another preferred embodiment of the present invention.

### DESCRIPTION OF THE PREFERRED EMBODIMENTS

The technical characteristics, contents, advantages and effects of the present invention will be apparent with the detailed description of a preferred embodiment accompanied with related drawings as follows.

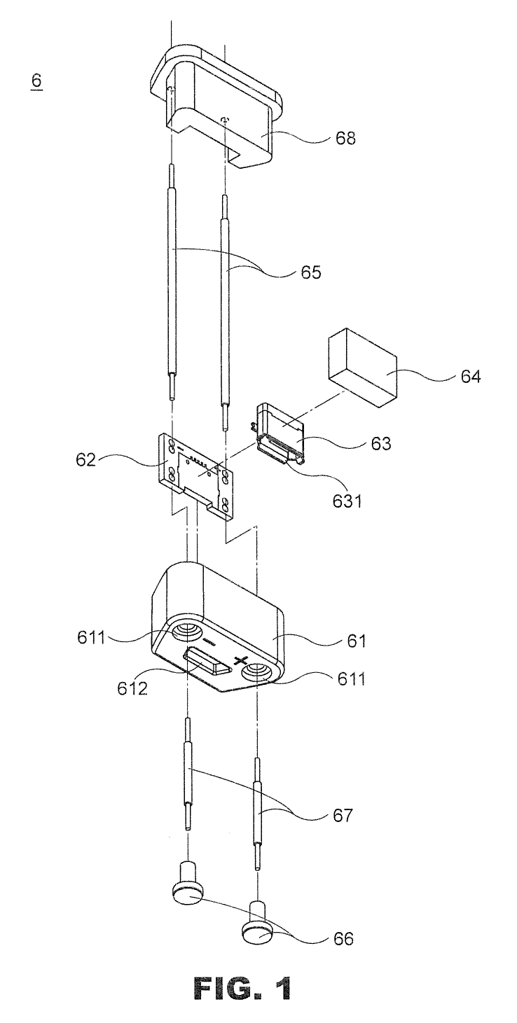

With reference to FIG. 1 for an exploded view of a power socket of the present invention, the waterproof structure is installed at the power socket 6, and the power socket 6 comprises: a base 61, having an accommodating space, two penetrating holes 611 and a slot 612; a circuit board 62, installed in the accommodating space of the base 61; a port 63, having an interface 631, and the port 63 being soldered to the circuit board 62, and the interface 631 of the port 63 being corresponsive to the slot 612 of the base 61; a thermosetting gel 64, for covering the port 63 and the soldered portion of the circuit board 62 and the port 63, and just keeping the interface 631 of the port 63; two first electronic wires 65, each having end soldered to the circuit board 62 and the other end soldered to an electrical storage device 5 (not shown in the figure); two contact points 66, aligned corresponsive to the penetrating holes 611 of the base 61 respectively; two second electronic wires 67, each having an end soldered to the circuit board 62 and the other end soldered to the contact point 66; and a cover 68 formed by a thermosetting gel by an injection molding method, so that the formed cover 68 can be packaged into the base 61.

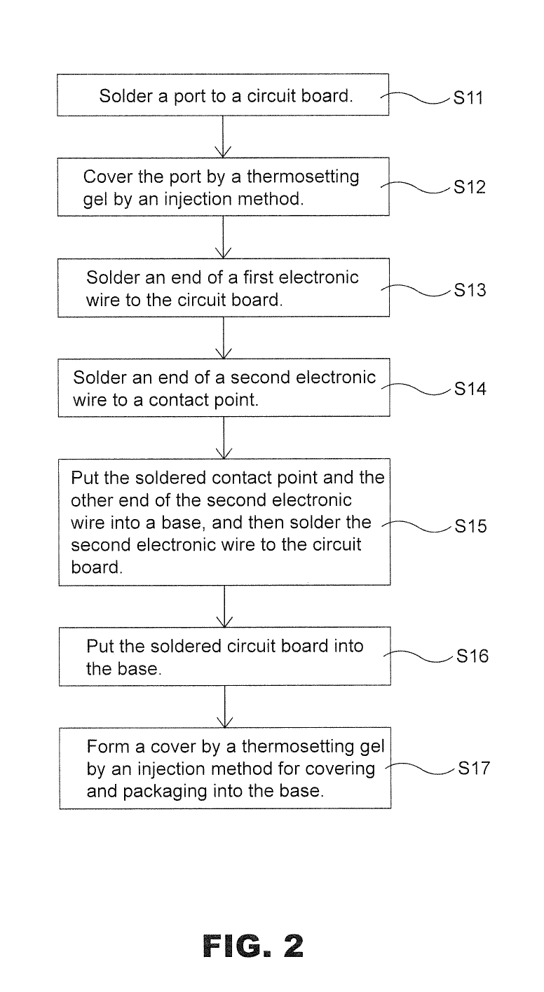

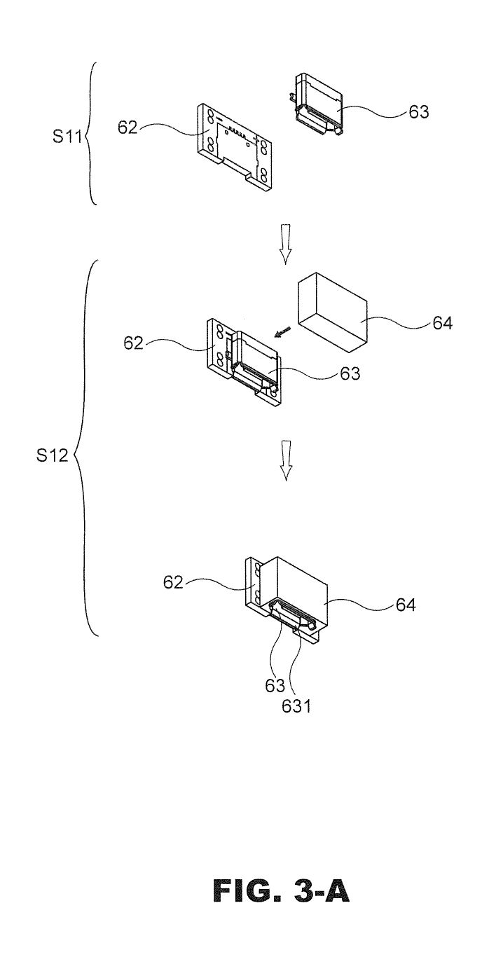

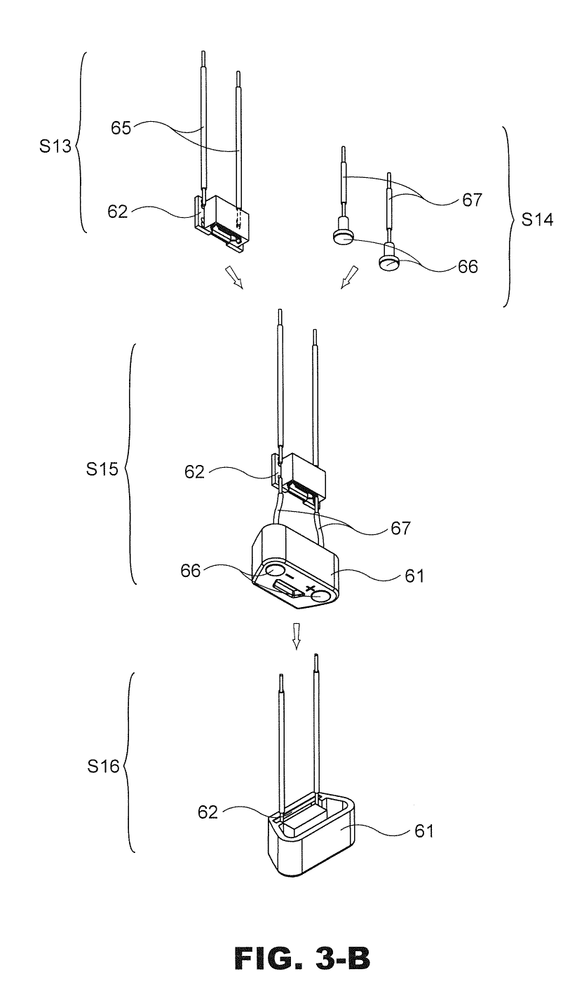

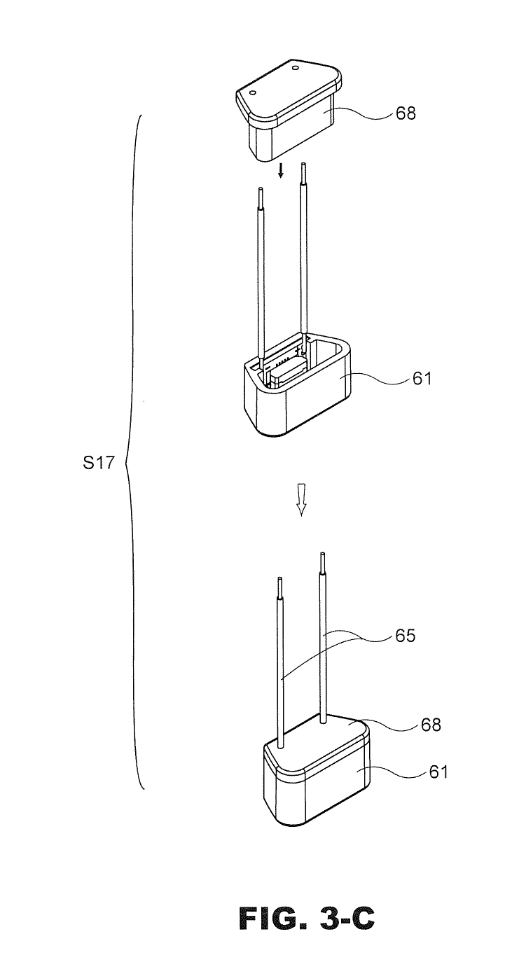

With reference to FIGS. 2, and 3-A˜3-C, the waterproof structure is manufactured by a method comprising the following steps:

S11: Solder a port 63 to a circuit board 61.

S12: Cover the port 63 by a thermosetting gel 64 by an injection method after the soldering takes place, and the covering range includes the port 63 and the soldered portion of the port 63 and the circuit board 62 and just keeping the interface 631 of the port 63.

S13: Solder an end of the first electronic wire 65 to the circuit board 62.

S14: Solder an end of the second electronic wire 67 to the contact point 66.

S15: Put the soldered contact point 66 and the other end of the second electronic wire 67 into the base 61, and then solder the second electronic wire 67 to the circuit board 62.

S16: Put the soldered circuit board 62 into the base 61.

S17: Integrally form a cover 68 by a thermosetting gel by an injection method, such that the formed cover 68 can be packaged into the base 61, and the other end of the first electronic wire 65 is passed through the base 61 to facilitate soldering am electrical storage device 5 (not shown in the figure).

Wherein, the port 63 is a micro universal serial bus (Micro USB) port.

Wherein, the thermosetting gel 64 is a material selected from the group consisting of acrylonitrile butadiene styrene (ABS), polyethylene (PE), polycarbonate (PC), polytetrafluoroethylene (PTFE), polyethylene terephthalate (PET), ethylene/vinyl acetate (EVA), polymethyl methacrylate (PMMN), polyoxymethylene (POM), styrene acrylonitrile (SAN), polystyrene (PS, EPS, ASA), polyamide (PA), polypropylene (PP), polyvinyl chloride (PVC) and polyurethane (PUR).

Wherein, the thermosetting gel of the cover 68 is a material selected from the group consisting of acrylonitrile butadiene styrene (ABS), polyethylene (PE), polycarbonate (PC), polytetrafluoroethylene (PTFE), polyethylene terephthalate (PET), ethylene/vinyl acetate (EVA), polymethyl methacrylate (PMMN), polyoxymethylene (POM), styrene acrylonitrile (SAN), polystyrene (PS, EPS, ASA), polyamide (PA), polypropylene (PP), polyvinyl chloride (PVC) and polyurethane (PUR).

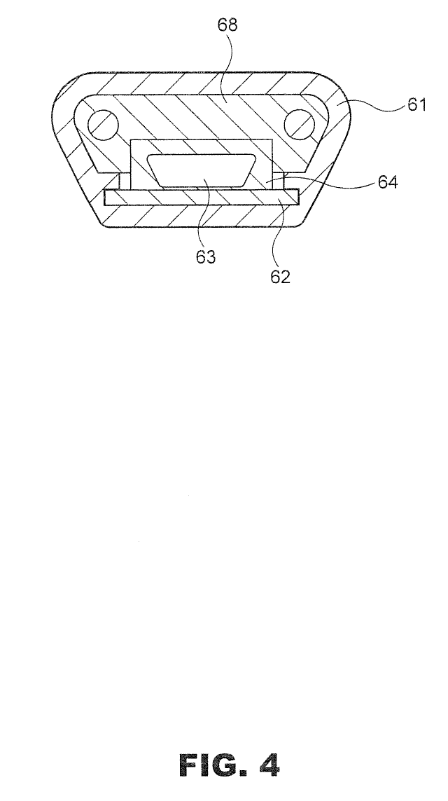

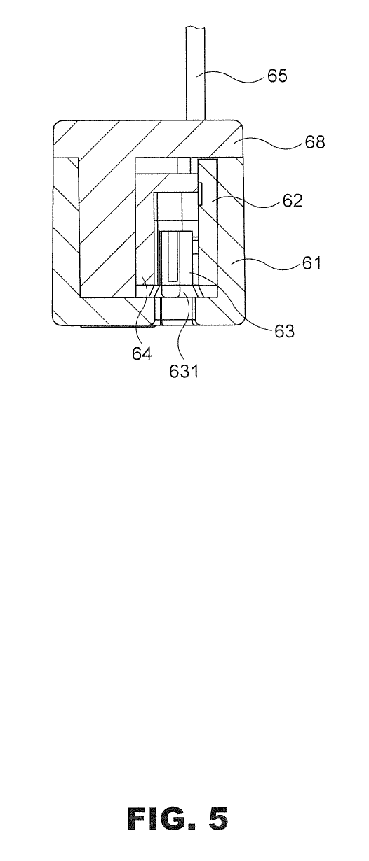

During assembling, the circuit board 62 with the soldered first electronic wire 65, second electronic wire 67 and port 63 and covered by the thermosetting gel 64 by the injection method is put into the accommodating space of the base 61 (refer to FIG. 1 as well), so that the interface 631 of the port 63 is precisely embedded into the slot 612 of the base 61, and the contact point 66 is put into the penetrating hole 611 of the base 61, and the cover 68 formed by the injection molding method is packaged into the base 61, so that the circuit board 62 and the port 63 are packaged into the base 61 and the cover 68 (as shown in FIG. 4). In addition, the port 63 in the base 61 is covered by both of the thermosetting gel 64 and the cover 68, so that the interface 631 of the port 63 and the interior of the base 61 will not produce any gap (refer to FIG. 5) so as to the moisture or dust in the air from entering from the gap of the interface 631 and achieve the waterproof and dustproof effects. In addition, the cover 68 is integrally formed and packaged into the base 61, so that the invention can skip the assembling and manufacturing process of the cover 68 and the base 61 and lower the manufacturing cost.

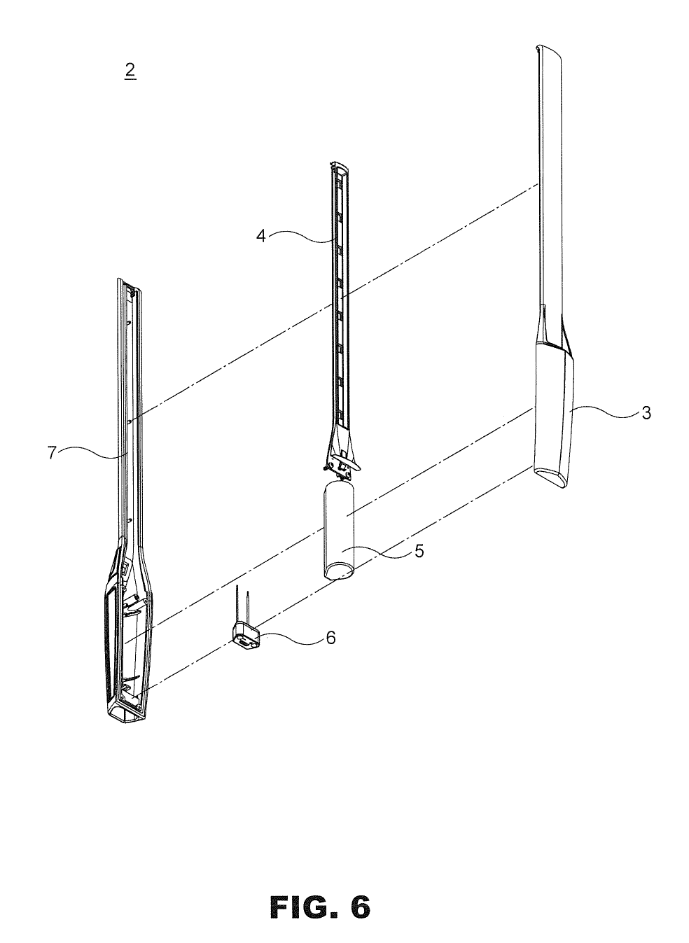

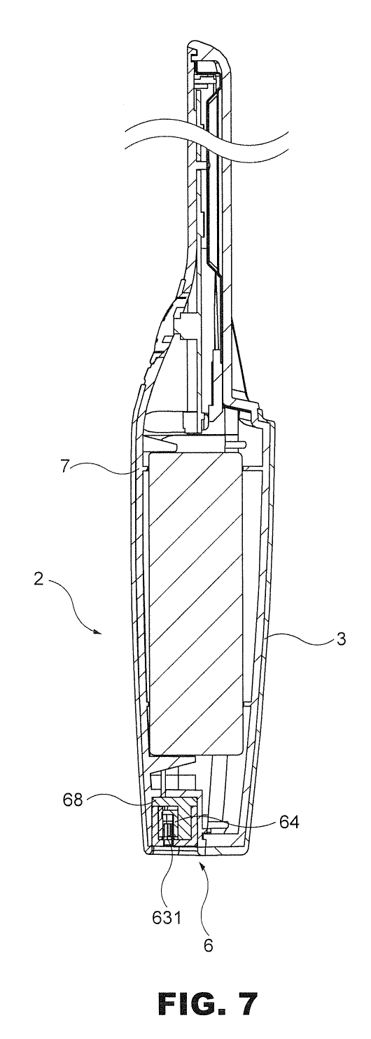

With reference to FIG. 6 for an exploded view of a handheld lamp of the present invention, the first electronic wire 65 of the power socket 6 of the assembled waterproof structure can be connected to the electrical storage device 5, and the electrical storage device 5 is connected to a light emitting component 4, and then the light emitting component 4, the electrical storage device 5 and the power socket 6 are installed in the accommodating space of a rear casing 7, and a front casing 3 is engaged with the rear casing 7 to form the handheld lamp 2. Since the port 63 of the power socket 6 is covered by both of the thermosetting gel 64 and the cover 68, therefore the interface 631 of the port 63 of the assembled handheld lamp 2 is packaged into the front casing 3 and the rear casing 7 (as shown in FIG. 7) to prevent moisture or dust from entering into the handheld lamp 2 from the interface 631 of the port 63, so as to improve the service life of the handheld lamp 2.

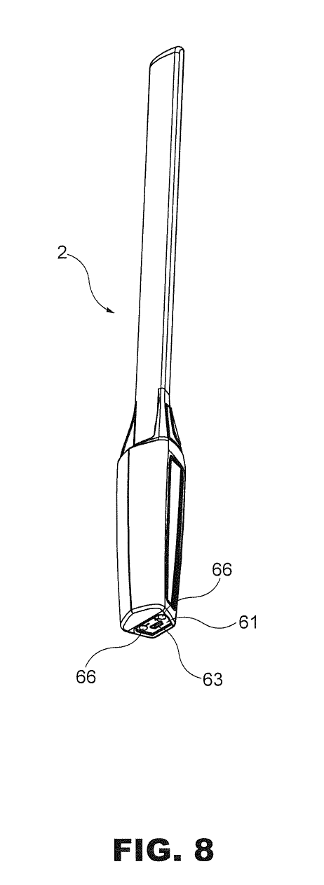

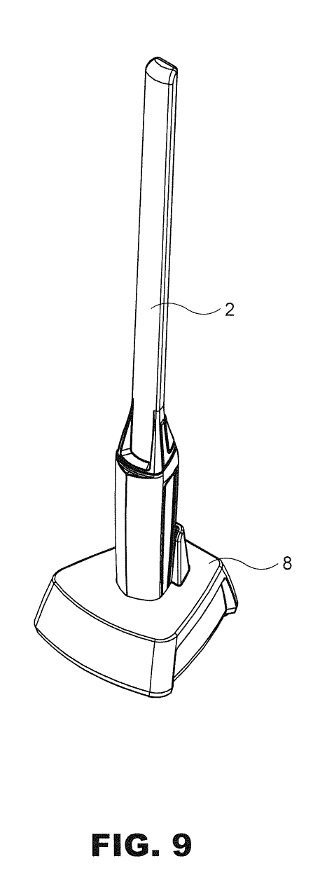

With reference to FIG. 8 for a perspective view of a handheld lamp of the present invention, an interface 631 of a port 63 and positive and negative electrode contact points 66 are formed at ends of the assembled handheld lamp 2, so that the handheld lamp 2 can be charged by a computer device through the port 63 and a compatible USB transmission line or by connecting to a socket through an adapter. In addition, the handheld lamp 2 includes a charger 8 (as shown in FIG. 9), so that the positive and negative electrode contact points 66 of the handheld lamp 2 can be connected to the charger 8 for charging the handheld lamp 2.

In summation of the description above, the present invention adopts thermosetting gel to achieve the waterproof effect of the handheld lamp and improves over the conventional lamp, and the invention complies with patent application requirements, and thus is duly filed for patent application.

While the invention has been described by means of specific embodiments, numerous modifications and variations could be made thereto by those skilled in the art without departing from the scope and spirit of the invention set forth in the claims.

What is claimed is:

1. A waterproof structure of a handheld lamp, comprising:
a base, having an accommodating space, two penetrating holes and a slot;
a circuit board, installed in the accommodating space of the base;
a port, soldered to the circuit board, and disposed at a position corresponding to the slot of the base:
a thermosetting gel, covered onto the port;
two first electronic wires, each having an end soldered to the circuit board, and the other end soldered to an electrical storage device;
two contact points, disposed at positions corresponding to the penetrating holes of the base respectively;
two second electronic wires, each having an end soldered to the circuit board, and the other end soldered to the contact point; and
a cover, formed by injecting the thermosetting gel, and packaged onto the base.

2. The waterproof structure of a handheld lamp according to claim 1, wherein the port is a micro universal serial bus (Micro USB) port.

3. The waterproof structure of a handheld lamp according to claim 1, wherein the thermosetting gel is a material selected from the group consisting of acrylonitrile butadiene styrene (ABS), polyethylene (PE), polycarbonate (PC), polytetrafluoroethylene (PTFE), polyethylene terephthalate (PET), ethylene/vinyl acetate (EVA), polymethyl methacrylate (PMMN), polyoxymethylene (POM), styrene acrylonitrile (SAN), polystyrene (PS, EPS, ASA), polyamide (PA), polypropylene (PP), polyvinyl chloride (PVC) and polyurethane (PUR).

4. The waterproof structure of a handheld lamp according to claim 1, wherein the thermosetting gel of the upper casing is a material selected from the group consisting of acrylonitrile butadiene styrene (ABS), polyethylene (PE), polycarbonate (PC), polytetrafluoroethylene (PTFE), polyethylene terephthalate (PET), ethylene/vinyl acetate (EVA), polymethyl methacrylate (PMMN), polyoxymethylene (POM), styrene acrylonitrile (SAN), polystyrene (PS, EPS, ASA), polyamide (PA), polypropylene (PP), polyvinyl chloride (PVC) and polyurethane (PUR).
